(19) United States
(12) Patent Application Publication
(10) Pub. No.: US 2002/0090456 A1
(43) Pub. Date: Jul. 11, 2002

(54) System and method for producing patterns on a roll of sheet metal using computer controlled printing heads

(76) Inventors: Norman A. Mackey, Churchville, PA (US); Philip R. Bucantis, Morrisville, PA (US); David C. Eltz, Levittown, PA (US); Jeffrey P. Gossner, Bensalem, PA (US); Joseph J. Robey, Fairless Hills, PA (US)

Correspondence Address: LaMORTE & ASSOCIATES, P.C., P.O. BOX 434, Yardley, PA, 19067-8434, US

(21) Appl. No.: 09/756,513

(22) Filed: Jan. 9, 2001

(51) Int. Cl. B05D 5/06

(52) U.S. Cl. 427/258

(57) ABSTRACT

A system and method for printing a predetermined pattern on sheet metal wound in a roll is claimed. The sheet metal is placed in a processing line, wherein the roll of sheet metal is unwound from a first roll, processed and rewound into a second roll. During processing, the sheet metal is cleaned and painted. The painted sheet metal is then advanced under at least one computer controlled printing head that prints a predetermined pattern of ink onto the sheet metal. The printed pattern of ink is then coated with a protective coating.

### BACKGROUND OF THE INVENTION

1. Field of The Invention

The present invention relates to systems and methods for creating patterns on rolls of sheet metal. More particularly, the present invention relates to systems and methods that process sheet metal by unrolling the sheet metal, cleaning the sheet metal, creating a pattern on the sheet metal, and then rewinding the sheet metal back into a roll.

2. Description of the Prior Art

In industry, there are many applications for sheet metal. Commonly, sheet metal is manufactured at a steel mill and is wound into large rolls for shipment. The rolls are then sent to various manufacturers who cut and form the sheet metal into component parts. Some manufacturers clean and paint the sheet metal after it has been manufactured into component parts. However, for many manufacturers, it is more practical to have the sheet metal cleaned, painted or otherwise treated before the sheet metal is wound onto a roll and shipped to the manufacturing facility. In this manner, component parts are nearly complete as soon as the sheet metal is removed from the roll and formed into a component part.

Many manufacturers process rolls of sheet metal. To process a roll of sheet metal, the sheet metal is first unwound from a roll. The sheet metal is then advanced through various processing stations, wherein the sheet metal is cleaned, chemically treated and/or painted. At the end of processing, the refinished sheet metal is again wound into a roll.

As sheet metal is advanced through various processing stations, the sheet metal is commonly treated with a variety of bases, acids and/or paints. If the sheet metal is painted, the sheet metal passes through a curing chamber to cure and dry the paint. Procedures for painting rolled sheet metal are exemplified by U.S. Pat. No. 3,663,383 to Matsuda, entitled, Method For Manufacturing Painted Sheet Metal.

Sheet metal is commonly painted by passing the sheet metal between roll coaters that apply a thin film of paint to the sheet metal. The use of roll coaters is an effective way to quickly coat sheet metal with an even coat of paint. However, it produces sheet metal that is a single color and has no pattern. If a manufacturer desires to produce a pattern on the sheet metal, the manufacturer must create engraved rolls. The engraved rolls are engraved with a desired pattern. The engraved rolls are coated with a thin film of secondary paint and are rolled against transfer rolls. The transfer rolls pick up the paint pattern from the engraved rolls and transfer that paint pattern onto the sheet metal.

There are many problems associated with the use of engraved rolls to form patterns on sheet metal. For example, the engraved rolls are expensive to create and add significantly to the cost of the finished sheet metal product. The cost of using the engraved rolls is ongoing because the engraved rolls wear out over time and must be periodically replaced and/or maintained. Furthermore, the pattern produced by the engraved rolls is not random. Rather, the pattern on the engraved roll repeats with every rotation of the engraved roll.

A need therefore exists for a low cost way to produce patterns on a roll of sheet metal that does not repeat and can be created in more than one color. This need is met by the present invention as it is described and claimed below.

### SUMMARY OF THE INVENTION

The present invention is system and method for printing a predetermined pattern on sheet metal wound in a roll. The sheet metal is placed in a processing line, wherein the roll of sheet metal is unwound from a first roll, processed and rewound into a second roll. During processing, the sheet metal is cleaned and painted. The painted sheet metal is then advanced under at least one computer controlled printing head that prints a predetermined pattern of ink onto the sheet metal. The printed pattern of ink is then coated with a protective coating.

By printing patterns onto the painted sheet metal, patterns can be created on the sheet metal that do not repeat and can contain multiple colors. Furthermore, the patterns printed in a single roll of sheet metal can be altered without stopping the movement of the sheet metal through the processing line.

### BRIEF DESCRIPTION OF THE DRAWINGS

For a better understanding of the present invention, reference is made to the following description of exemplary embodiments thereof, considered in conjunction with the accompanying drawings, in which:

FIG. 1 is a schematic view of a system of printing a pattern onto a roll of sheet metal, in accordance with the present invention;

FIG. 2 is a fragmented view of a sheet metal processing line in the area of the application of the computer controlled printing heads; and

FIG. 3 is a perspective view of a segment of sheet metal for use in the construction of an above-ground pool.

### DETAILED DESCRIPTION OF THE INVENTION

Although the present invention system and method can be used to print a selected pattern on any rolled metal material, such as cold rolled steel, galvanized steel, stainless steel, aluminum, and the like, the present invention is particularly well suited for printing such patterns on rolled steel sheet metal. Accordingly, by way of example, the present invention system and method will be described in an application where it is used to print a selected pattern on steel sheet metal.

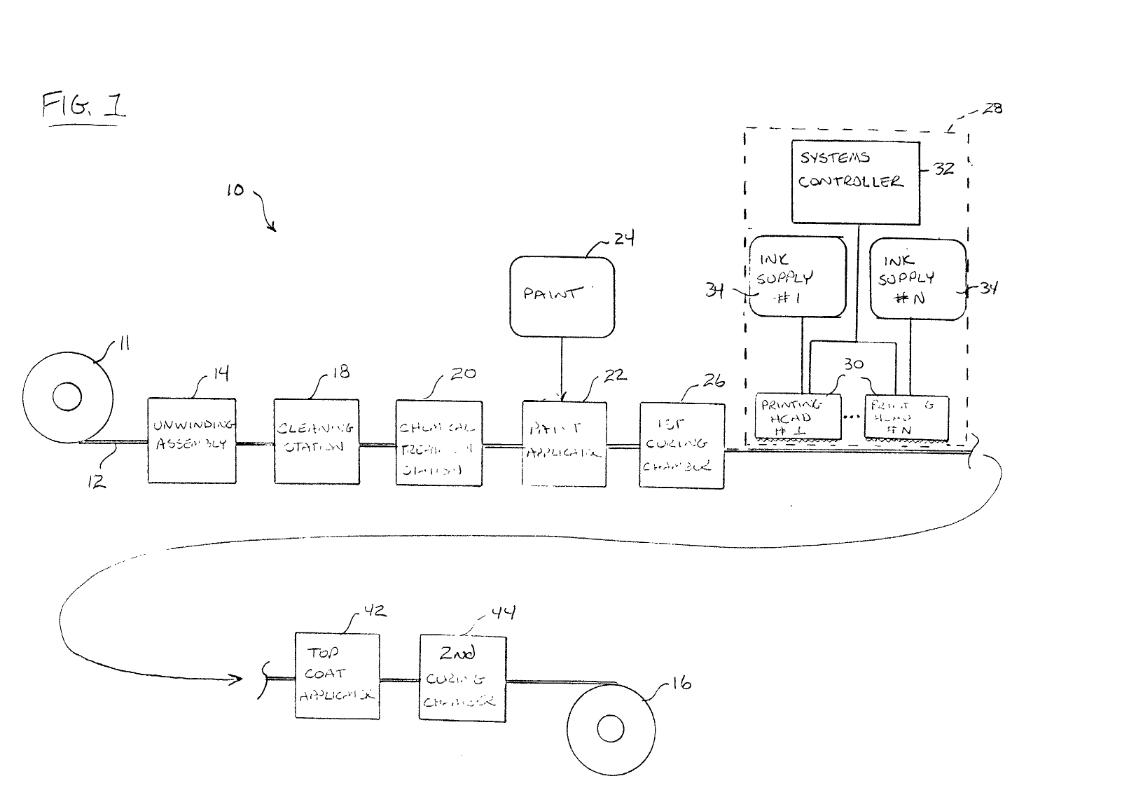

Referring to FIG. 1, there is shown a schematic of an exemplary embodiment of the present invention system 10. The schematic illustrates the major processing steps performed on a roll of sheet metal as a selected pattern is printed onto the sheet metal.

The processing begins with a roll 11 of raw sheet metal 12, as it would be produced by a steel mill. The sheet metal 12 is unwound from its original roll 11 by an unwinding assembly 14 and is fed into a processing line. The processing line contains a plurality of processing stations, which will be described. At the opposite end of the processing line, the sheet metal 12 is again wound into a finished roll 16.

After the sheet metal 12 is unwound from its original roll 11, the sheet metal 12 is advanced through a cleaning station 18. At the cleaning station 18, the sheet metal 12 is treated with degreasing solvents and rinsed. The cleaned sheet metal 12 may then be advanced through a chemical treatment station 20, wherein the sheet metal 12 is chemically treated. The chemical treatment used on the sheet metal 12 depends upon the composition of the sheet metal 12 and can include, acid baths, alkaline baths, complex oxides, phosphate treatments or any other chemical treatment commonly used to treat the surface of different types of rolled metal alloys.

After the sheet metal 12 is cleaned and optionally chemically treated, the sheet metal 12 is advanced through a primary paint applicator 22. The sheet metal 12 is coated in a first color of primary paint 24. The primary paint 24 is preferably applied by a roll coater that selectively applies a film of the primary paint 24 that is between one tenth of a millimeter and ten millimeters thick.

As the sheet metal 12 exits the primary paint applicator 22, the primary paint 24 is still wet. The painted sheet metal is then advanced through a curing chamber 26 that cures the primary paint.

The painted surface of the sheet metal 12 is the substrate upon which a preselected design is to be printed. After the sheet metal 12 exits the curing chamber 26, the sheet metal 12 advances through a printing station 28. In the printing station 28, there is at least one printing head 30. Each printing head 30 is coupled to a programmable systems controller 32 and a source of ink 34. There are many types of printing heads that are used in industry to print on paper and other traditional parchment substrates. However, such printing heads are designed to print ink onto paper or another traditional parchment substrate. For use with the present invention, the design of traditional ink jet printing heads is modified to the task of printing ink onto painted metal that is continuously moving through a processing line. Each ink jet printing head 30 is elongated to be at least as long as the width of the passing sheet metal 12. As such, each ink jet printing head 30 is preferably made to be at least sixty inches long. Each ink jet printing head 30 is positioned over the sheet metal 12 at a perpendicular to the direction of travel associated with the sheet metal 12. As such, the entire width of the sheet metal 12 will pass under a segment of each ink jet printing head 30 as the sheet metal moves through the printing station 28.

Another modification made to each ink jet printing head 30 is a dramatic increase in dispensing volume. In a sheet metal processing line, the sheet metal 12 advances through the line at a rate of between one hundred feet per minute and four hundred feet per minute. The dispensing output of each ink jet printing head 30 is designed with a maximum output that is capable of completely covering the moving sheet metal 12 with a layer of ink that is at least one tenth of a millimeter thick.

The ink jet printing heads 30 preferably have the ability to print pixel points at a density of at least 600 ppi. However, printing heads with a resolution as low as 200 ppi can be used for certain patterns and rapid sheet metal velocities.

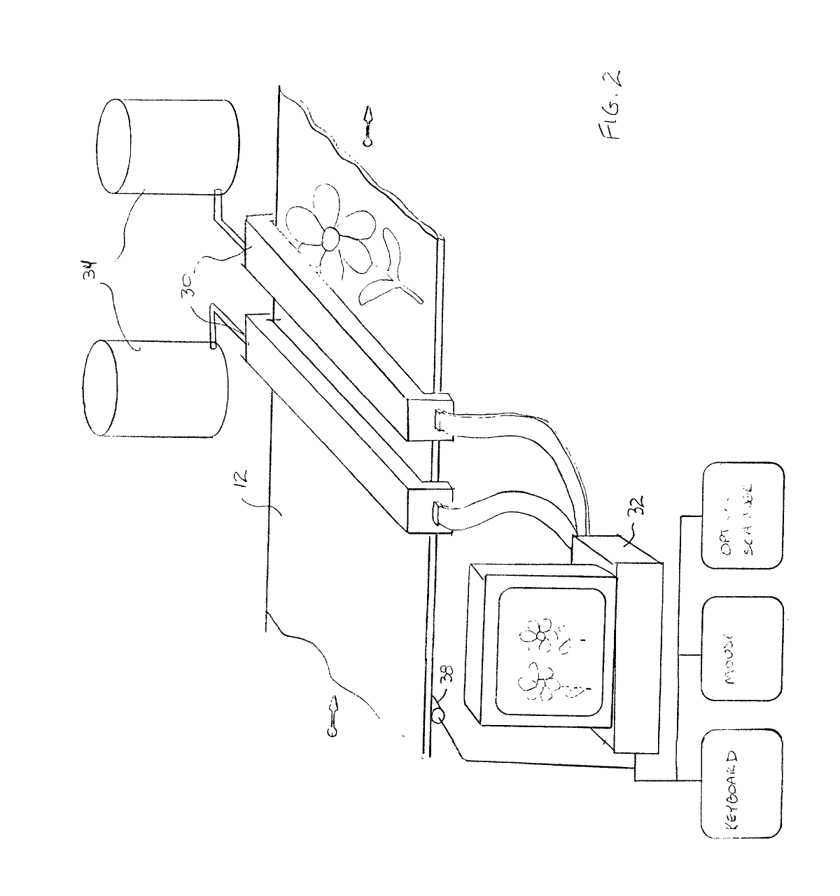

Referring to FIG. 2, it can be seen that the printing station may contain multiple ink jet printing heads 30. Each of the ink jet printing heads 30 extends across the width of the sheet metal 12. Each ink jet printing head 30 is fed by an ink supply 34. The color of the different ink supplies 34 can be the same or can be different. If different color ink supplies 34 are used, the ink jet printing heads 30 can produce an image on the sheet metal 12 that contains multiple colors.

All of the ink jet printing heads 30 are controlled by a single systems controller 32. The systems controller 32 is a computer that contains the needed software to control the functions of the various ink jet printing heads 30. In order for the systems controller 32 to coordinate the dispensing of ink from the various ink jet printing heads 30 to accurately create a needed design, certain variables must be known by the systems controller 32. One of the variables that must be known is the exact speed of the sheet metal 12 passing under the ink jet printing heads 30. The speed of the sheet metal 12 is needed to calculate the amount of ink to be dispensed from each of the ink jet printing heads 30 and when that ink is to be dispensed. To know the exact speed of the moving sheet metal 12, a velocity sensor 38 is provided. The velocity sensor 38 can detect the actual speed of the sheet metal 12 moving through the printing station either mechanically or optically. The velocity sensor 38 is coupled to the systems controller 32 and informs the systems controller 32 of the exact speed of the moving sheet metal 12. The information transferred to the systems controller 32 is continuously updated. As such, small variations in the speed of the moving sheet metal 12 can be instantly detected by the systems controller 32.

The second variable that must be known by the systems controller 32 is the image and/or pattern that is to be produced by the ink jet printing heads 30. Such an image and/or pattern can be loaded into the systems controller 32 as a data file, either via a storage disc or as a data transfer through a computer network. Alternatively, the systems controller 32 may also include a data input interface, such as an optical scanner, keyboard and mouse, so that different images and patterns can be created directly within the systems controller 32.

Once the systems controller 32 knows what image and/or pattern is to be produced and the speed of the moving sheet metal, the systems controller 32 can control the various ink jet printing heads 30 so that the printing heads 30 reproduce that image and/or pattern onto the moving sheet metal 12.

Returning to FIG. 1, it can be seen that once the ink jet printing heads 30 print the desired image and/or pattern onto the moving sheet metal 12, the deposited ink can be allowed to air dry.

Once the printed ink is cured, the sheet metal 12 advances through a coating applicator 42. The coating applicator applies a protective top coat of transparent material over the ink. The protective top coat can be applied by spraying. Alternatively, the protective top coat can be applied by a roll coater that selectively applies a film of the protective top coat that is between one tenth of a millimeter and ten millimeters thick. After the application of the protective top coat, the sheet metal 12 is again advanced through a curing chamber 44 that cures the protective top coat.

The top coat is water resistant when cured. As such, the protective top coat protects the underlying ink from the elements. This enables low cost inks to be used that otherwise would not be usable if left exposed to the elements.

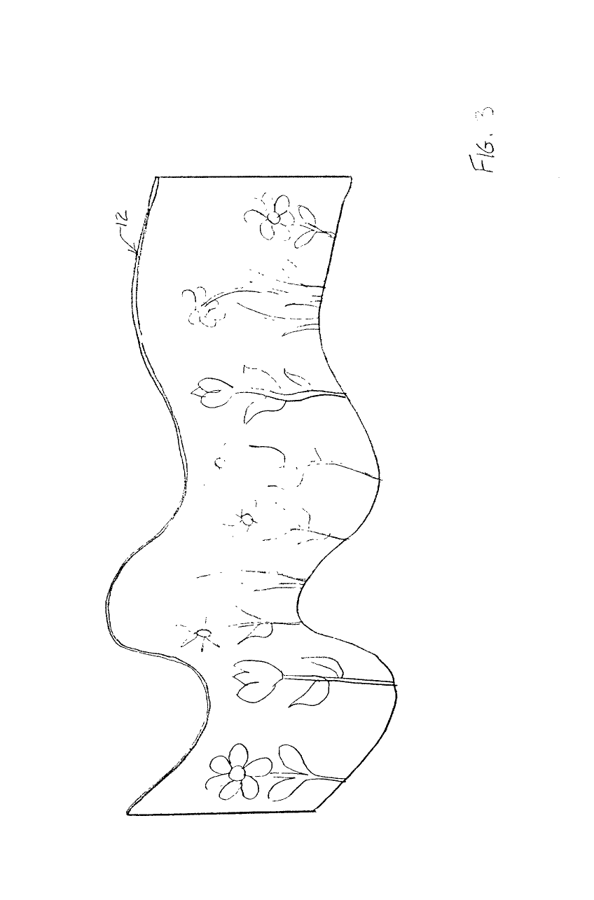

Referring to FIG. 3, a segment of a roll of sheet metal 12 is shown upon which has been printed an image. The image does not repeat. Rather, the image is unique from one end of the segment of sheet metal 12 to the other. The segment of sheet metal 12 can be used to create many consumer products, for instance a backyard pool. As such, the image on the product would be different from every different angle of viewing the product.

Since the image and/or pattern printed on the sheet metal is controlled by the systems controller 32 (FIG. 2), different segments of the same roll of sheet metal 12 can be printed with different images and/or patterns without having to change any physical aspect of the sheet metal processing line. In fact, different segments of the same roll of sheet metal can be printed with different images and/or patterns without even stopping the movement of the sheet metal in the processing line.

Furthermore, since the image and/or pattern is programmed into the systems controller 32 (FIG. 2) custom orders can be created for individual customers. These custom orders can be created in different sections of the same roll of sheet metal without stopping the movement of the sheet metal through the processing line. Accordingly, if a customer has a garden with yellow flowers in her backyard, that customer can order an above-ground pool, having sheet metal decorated as a garden with yellow flowers. Customers can therefore select the image and/or pattern on the sheet metal to match any color scheme or image they desire.

In the embodiments described, the printed pattern of ink is applied to only one side of the sheet metal. It should be understood that by placing printing heads on either side of the sheet metal, the printed patterns can be created on both sides of the sheet metal.

Although stationary ink jet printing heads 30 are shown in the embodiment of FIG. 2, it will be understood that the ink jet printing heads 30 can either be stationary or can track back and forth across the width of the passing sheet metal 12. Stationary ink jet printing heads 30 can be used if the length of the printing heads 30 is at least as long as the sheet metal 12 is wide. Moving ink jet printing heads can be used if the number and size of spray heads is insufficient to cover the passing sheet metal from a stationary point.

It will be understood that the various figures described above illustrate only an exemplary embodiment of the present invention. A person skilled in the art can therefore make numerous alterations and modifications to the shown embodiments utilizing functionally equivalent components to those shown and described. All such modifications are intended to be included within the scope of the present invention as defined by the appended claims.

What is claimed is:

1. A method for applying a pattern to a roll of sheet metal, comprising the steps of:
applying a layer of paint to the sheet metal,
printing a pattern of ink onto said layer of paint;
applying a protective coating over said pattern of ink.

2. The method according to claim 1, wherein said step of printing a pattern of ink includes passing the sheet metal under at least one computer controlled printing head.

3. The method according to claim 2, wherein said at least one computer controlled printing head includes an ink jet printing head.

4. The method according to claim 1, further including the step of continuously passing the sheet metal from a first unwinding roll to a second winding roll, wherein said step of printing a pattern of ink occurs while the sheet metal is moving between said first unwinding roll and said second winding roll.

5. The method according to claim 1, wherein said step of applying a uniform layer of paint includes advancing the sheet metal through a roll coater.

6. The method according to claim 1, further including the step of cleaning the sheet metal prior to the step of applying a layer of paint.

7. The method according to claim 1, wherein said step of applying a pattern of ink includes passing the sheet metal under a first printing head that applies a first color ink and a second printing head that applies a second color ink.

8. A system for creating a pattern on sheet metal, comprising:
a paint applicator for applying a layer of paint onto the sheet metal;
at least one printing head for printing ink onto said layer of paint in a predetermined pattern;
a top coat applicator for applying a protective coating over said predetermined pattern.

9. The system according to claim 8, wherein said paint applicator includes a roll coater.

10. The system according to claim 8, wherein said at least one printing head includes an ink jet printing head.

11. The system according to claim 8 wherein each said at least one printing head is at least as long as the sheet metal is wide.

12. The system according to claim 8, further including a mechanism for continuously advancing the sheet metal past said paint applicator, said at least one printing head and said top coat applicator.

13. The system according to claim 8, further including a systems controller for operating said at least one printing head, wherein said systems controller instructs said at least one printing head to create said predetermined pattern.

14. A method of printing a predetermined pattern on sheet metal contained in a roll of sheet metal, said method comprising the steps of:
unrolling the sheet metal from the roll of sheet metal;
painting at least one surface of the sheet metal with paint, thereby creating at least one painted surface;
printing ink onto said at least one painted surface using a computer controlled printing head, thereby creating a predetermined pattern onto the sheet metal.

15. The method according to claim 14, further including the step of rewinding the sheet metal into a roll after said step of printing.

16. The method according to claim 14, further including the step of coating said predetermined pattern with a protective coating.

17. The method according to claim 14, wherein said step of painting at least one surface of the sheet metal includes passing the sheet metal through a roll coater.

18. The method according to claim 14, wherein said predetermined pattern does not repeat.
